(19) United States
(12) Patent Application Publication
(10) Pub. No.: US 2013/0266177 A1
(43) Pub. Date: Oct. 10, 2013

(54) Method and Device for Detecting an Object in an Image

(71) Applicant: Michel Sanches, Le Pont-de-Claix (FR)

(72) Inventor: Michel Sanches, Le Pont-de-Claix (FR)

(73) Assignee: STMICROELECTRONICS (GRENOBLE 2) SAS, Grenoble (FR)

(21) Appl. No.: 13/619,819

(22) Filed: Sep. 14, 2012

(30) Foreign Application Priority Data
Apr. 6, 2012 (FR) 1253206

(51) Int. Cl. G06K 9/62

(52) U.S. Cl. 382/103

(57) ABSTRACT

A method for detecting an object in an image by means of an image processing device, includes several steps of object search in the image at different search scales. During at least one of the search steps, portions of the image are excluded from the search. The size of the portions decreases as the search scale increases.

### CROSS-REFERENCE TO RELATED APPLICATIONS

This application claims priority to French patent application Ser. No. 12/53206, which was filed Apr. 6, 2012 and is incorporated herein by reference.

### TECHNICAL FIELD

The invention relates generally to image processing and, in particular embodiments to a method and device for detecting an object in an image.

### BACKGROUND

In many applications, it is desired to be able to detect, in an image taken by a sensor of a video or photographic camera, an object at an unknown distance from the sensor at the time of the shooting, and accordingly having a size in the image, in pixels, of unknown order of magnitude. This issue arises, for example, in systems of vehicle detection in images taken by a road video surveillance camera, or in face detection systems.

Known multi-scale detection methods provide searching for the possible presence of the object in the image by exhaustively scanning the image, at all positions and at all possible search scales. Examples of methods of multi-scale object detection are especially described in article “Robust Real-time Object Detection” by Paul Viola and Michael Jones.

FIG. 1 schematically illustrates steps of an example of a method of multi-scale detection of an object (not shown) in an image I₀. This method comprises three successive steps 100, 101, and 102 of search of the object in image I₀, at three different search scales.

At step 100, a sliding detection window r₀ is defined. As an example, image I₀ has a 384×288-pixel resolution, for example corresponding to the resolution of the sensor which has taken image I₀, and window r₀ is a square 24×24-pixel window. Image I₀ is entirely scanned by the shifting of sliding window r₀ by a given step in the horizontal direction and by a given step in the vertical direction, for example, by a 1-pixel step in the horizontal direction and by a 1-pixel step in the vertical direction. For each shifting of window r₀, a detection algorithm is implemented to determine whether the searched object is or not contained within window r₀ at a size on the order of that of window r₀. Thus, step 100 enables, in this example, to detect the searched object if its size in image I₀ is on the order of 24×24 pixels.

At step 101, a second search at a search scale greater than that of step 100 is carried out. An image I₁ of smaller dimensions than image I₀ is first computed, which corresponds to a simulation of an image which could have been acquired with a sensor of lower resolution. As an example, the size of image I₁ is smaller by a factor 1.5 than the size of image I₀, that is, in the above mentioned example of an original image I₀ of 384×288 pixels, image I₁ has a 256×192-pixel resolution. Image I₁ may be obtained by the succession of a step of low-pass filtering or averaging of image I₀, and of a sub-sampling step. Image I₁ is then entirely scanned by using the same sliding detection window r₀ as at step 100. For each shifting of window r₀, a detection algorithm is implemented to determine whether the searched object is or not contained within window r₀ at a size on the order of that of window r₀. Step 101 thus enables, in this example, to detect the searched object if its size in image I₁ is on the order of 24×24 pixels, that is, if its size in image I₀ is on the order of (1.5*24)×(1.5*24)=36×36 pixels.

At step 102, a third search at a search scale greater than that of step 101 is carried out. An image I₂ of smaller size than image I₁ is calculated from image I₁ or from image I₀. As an example, the size of image I₂ may be smaller by a factor 1.5 than the size of image I₁, that is, in the above mentioned example, image I₂ has a 170×128-pixel resolution. Image I₂ is entirely scanned by using the same sliding detection window r₀ as at steps 100 and 101. For each shifting of window r₀, a detection algorithm is implemented to determine whether the searched object is or not contained within window r₀ at a size on the order of that of window r₀. Step 102 thus enables, in this example, to detect the searched object if its size in image I₂ is on the order of 24×24 pixels, that is, if its size in image I₀ is on the order of (1.5*1.5*24)×(1.5*1.5*24)=54×54 pixels.

FIG. 2 schematically illustrates steps of another example of a method of multi-scale detection of an object (not shown) in an image I₀. This method comprises three successive steps 200, 201, and 202 of search of the object in image I₀, at three different search scales.

Step 200 is identical to step 100 of the method of FIG. 1, that is, image I₀ is entirely scanned by means of a sliding detection window r₀, for example, by a window of 24×24 pixels for an image I₀ of 384×288 pixels. For each shifting of window r₀, a detection algorithm is implemented to determine whether the searched object is or not contained within window r₀ at a size on the order of that of window r₀.

At step 201, a second search at a search scale greater than that of step 200 is carried out. A new sliding detection window r₁, of larger dimensions than window r₀, is defined. As an example, the size of window r₁ is larger by a factor 1.5 than that of window r₀. Image I₀ is entirely scanned by means of window r₁. For each shifting of window r₁, a detection algorithm is implemented to determine whether the searched object is or not contained within window r₁ at a size on the order of that of window r₁ ((24*1.5)×(24*1.5)=36×36 pixels in this example).

At step 202, a third search at a search scale greater than that of step 201 is carried out. A new sliding detection window r₂, of larger size than window r₁, is defined. As an example, the size of window r₂ is 1.5 times greater than that of window r₁. Image I₀ is entirely scanned by means of window r₂. For each shifting of window r₂, a detection algorithm is implemented to determine whether the searched object is or not contained within window r₂ at a size on the order of that of window r₂ ((1.5*1.5*24)×(1.5*1.5*24)=54*54 pixels in this example).

In the examples of FIGS. 1 and 2, for simplification, only 3 successive steps of object search in image I₀ at different search scales have been shown and described. In practice, there may be a larger number of search steps at different scales, for example, more than 10, this number and the multiplication factor of the search scale between two successive search steps being adaptable according to the desired detection performance.

A disadvantage of multi-scale detection methods of the type described in relation with FIGS. 1 and 2 is that they perform a large number of computing operations, which limits the maximum number of images that can be processed per time unit.

### SUMMARY OF THE INVENTION

Embodiments of the present invention relate to a method and a device for automatically detecting one or several objects in an image. In specific embodiments, a method and device for multi-scale detection are enabled to detect objects having a size in the image which is not known beforehand.

An embodiment provides a method of multi-scale detection of an object in an image which overcomes at least some of the disadvantages of known methods.

An embodiment provides a method of multi-scale detection of an object in an image implementing less computing operations than known methods.

Another embodiment provides a device of multi-scale detection of an object in an image.

Thus, an embodiment provides a method for detecting an object in an image by means of an image processing device, comprising several steps of object search in the image at different search scales, wherein at least one of the search steps, portions of the image are excluded from the search, the size of said portions decreasing as the search scale increases.

According to an embodiment, at each of the search steps, a sliding detection window is used to scan said image or a resized image representative of the image, a detection algorithm being implemented on each shifting of the window to determine whether the searched object is or not contained within the window at a size on the order of that of the window.

According to an embodiment, between two successive search steps at different search scales, the search scale change is performed by modifying the size of the image scanned by said window.

According to an embodiment, between two successive search steps at different search scales, the search scale change is performed by modifying the size of the sliding window.

According to an embodiment, when the search scale is greater than a threshold, no portion of the image is excluded from the search.

According to an embodiment, when the search scale is smaller than said threshold, the size of the portions depends on the search scale according to a linear function.

According to an embodiment, the object to be detected is a face.

According to an embodiment, the object to be detected is a vehicle.

Another embodiment provides a device for detecting an object in an image, comprising a processing unit and a memory capable of storing said image, the processing unit being connected to the memory and being configured to carry out several steps of object search in the image at different search scales and, at least at one of the search steps, to exclude portions of the image from the search, the size of said portions decreasing as the search scale increases.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 schematically illustrates steps of an example of a method of multi-scale detection of an object in an image;

FIG. 2, previously described, schematically illustrates steps of another example of a method of multi-scale detection of an object in an image;

FIG. 3 schematically illustrates an automatic face detection system;

FIG. 4 schematically illustrates steps of an embodiment of a method of multi-scale detection of an object in an image;

FIG. 5 schematically illustrates steps of a variation of the multi-scale detection method of FIG. 4; and

FIG. 6 schematically illustrates an embodiment of a device of multi-scale detection of an object in an image.

### DETAILED DESCRIPTION OF ILLUSTRATIVE EMBODIMENTS

For clarity, the same elements have been designated with the same reference numerals in the different drawings and, further, the various drawings are not to scale. Further, only those elements which are useful to the understanding of the present invention have been described. In particular, the algorithms capable of being used to detect whether the searched object is or not contained within a sliding detection window at a size on the order of that of the window have not been described, the described embodiments being compatible with all known detection algorithms.

FIG. 3 schematically shows, as an illustration, an example of an automatic face detection system comprising a camera 301 maintained above the ground, for example, at a height of approximately 1.5 m (5 ft.), by a support stand 303. The system is configured to automatically detect the possible presence of a face 305 in the field of view of camera 301, at a distance from the camera that may for example range from a few tens of centimeters to several meters.

When face 305 is distant from the camera, it only takes up a small part of the image taken by the camera. However, when face 305 is close to the camera, it takes up a great part of the image taken by the camera, or even all of it.

Beyond a distance d from the camera especially depending of the system layout and configuration, the field of view of the camera comprises portions where it is in practice impossible for a face to be present. As an example, in FIG. 3, it is in practice impossible or very unlikely for a face to be present in hatched regions 307a and 307b of the field of view of the camera, respectively corresponding to the lower portion of the field of view of the camera, for example located at less than a few centimeters above the ground, and to the upper portion of the field of view of the camera, for example located at more than 2.5 meters above the ground.

Generally, in most automatic object detection systems, beyond a given distance from the camera, the field of view of the camera comprises portions where, in practice, it is impossible or very unlikely for the object to the detected to be present.

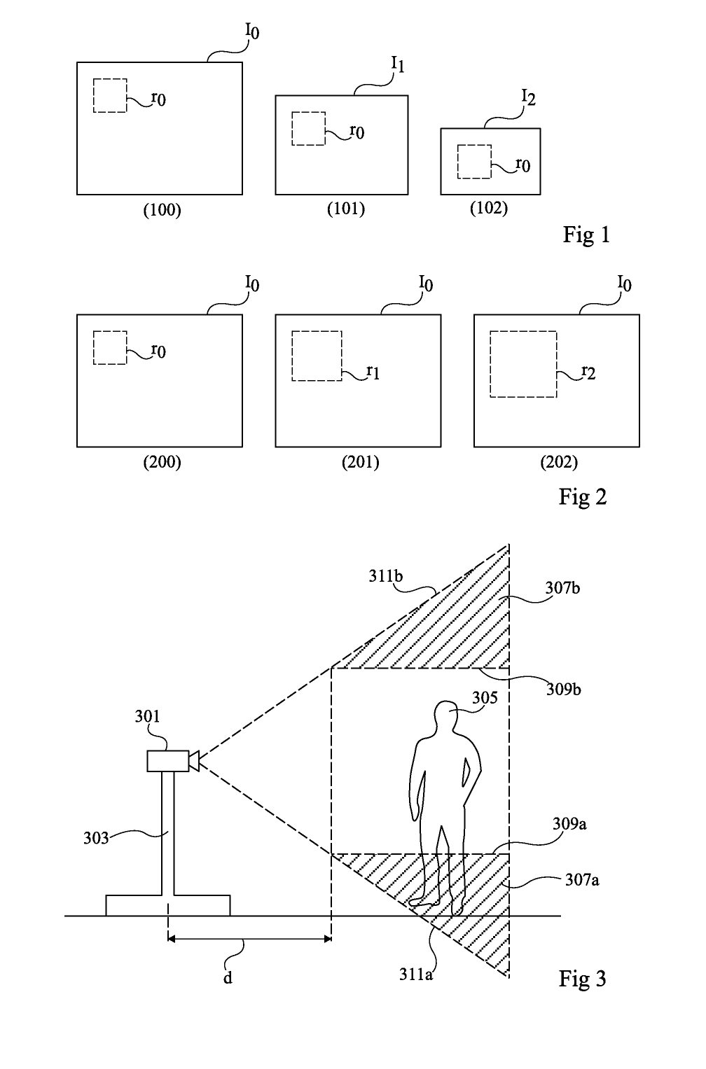

In known multi-scale detection methods, since the distance to the camera of the object to be detected at the time of the shooting is not known in advance, it is provided to search out the object by exhaustively scanning the image, at all positions, as described in relation with FIGS. 1 and 2.

An aspect of an embodiment provides a method of multi-scale detection of an object in an image, comprising several steps of object search in the image at different search scales, wherein, during search steps at the smallest scales, areas of the image are excluded from the search, the size of these areas at the scale of the original image decreasing as the search scale increases. When the search scale exceeds a threshold, the areas excluded from the search may totally disappear.

It should be noted that in the present description, search scale designates the ratio of the order of magnitude of the size, in pixels in the original image, of the searched object, to the size of the original image. There is a correspondence between the search scale used at a given search step and the order of magnitude of the supposed distance between the sensor and the searched object at the time when the image is taken. The search scale used is all the larger as an object close to the camera is searched, and all the smaller as an object remote from the camera is searched. In the examples of FIGS. 1 and 2, at each search step, one may define a horizontal search scale as being the ratio of the horizontal dimension of the sliding window to the horizontal dimension of the image scanned by this window, and a vertical search scale as being the ratio of the vertical dimension of the sliding window to the vertical dimension of the image scanned by this window. As an illustration, the horizontal search scales at steps 100, 101, 102, 200, 201, and 202 of the methods of FIGS. 1 and 2 respectively are 24/384, 24/256, 24/170, 24/384, 36/384, and 54/384, and the vertical search scales at these same steps respectively are 24/288, 24/192, 24/128, 24/288, 36/288, and 54/288.

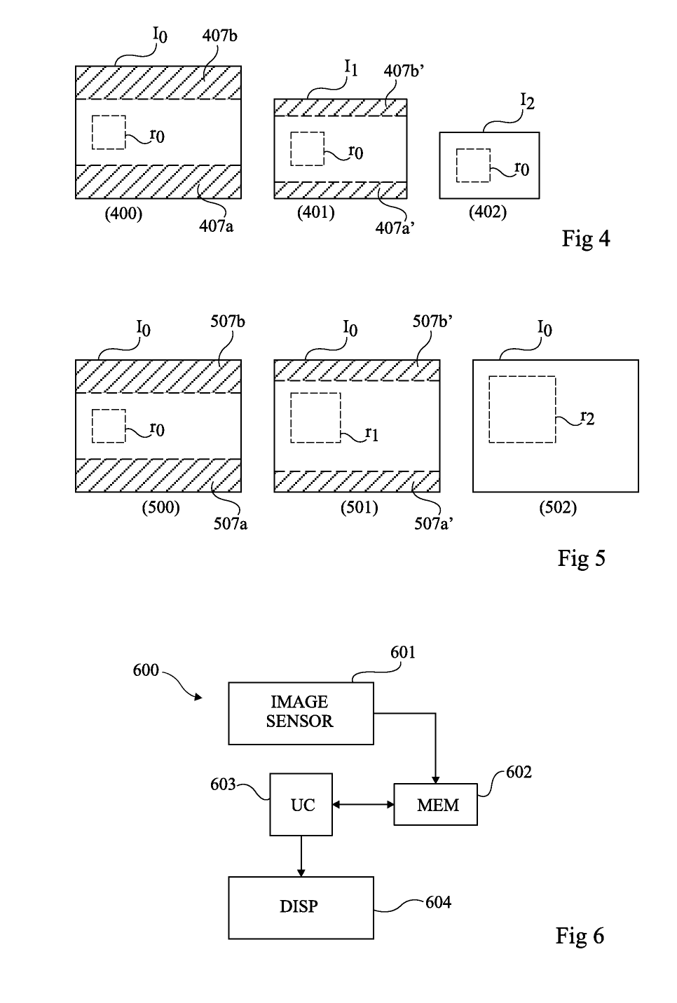

FIG. 4 schematically illustrates steps of an embodiment of a method of multi-scale search of an object (not shown) in an image I₀. In the shown example, the method comprises three steps 400, 401, and 402 of search of the object in image I₀, at three different search scales.

At step 400, it is attempted to detect the possible presence of the object at a relatively large distance from the camera (small search scale). At such a distance, the field of view of the camera comprises regions where it is in practice impossible or very unlikely for the searched object to be located. It is provided to exclude the image areas corresponding to these regions from the search. In the shown example, a lower horizontal strip 407a and an upper horizontal strip 407b of image I₀ are excluded from the search at step 400, which strips respectively correspond to a lower portion and to an upper portion of the field of view of the camera (configuration of the type illustrated in FIG. 3). As an example, image I₀ has a 384×288-pixel resolution, and strips 407a and 407b each have a size of 384×100 pixels. A sliding detection window r₀, for example, a square 24×24-pixel window, is used to scan the entire image I₀ excluding strips 407a and 407b. For each shifting of window r₀, an algorithm is implemented to determine whether the searched object is or not contained in window r₀ at dimensions on the order of those of window r₀.

At step 401, it is attempted to detect the possible presence of the object at a distance from the camera smaller than the search distance of step 400 (greater search scale than at step 400). At such a distance, there remain regions of the camera field of view where it is in practice impossible or very unlikely for the searched object to be located. It is provided to exclude the image areas corresponding to these regions from the search, it being understood that these areas are, at the scale of image I₀, smaller than areas 407a and 407b excluded at step 400 (see the illustration in FIG. 3).

As an example, in the above-mentioned case where original image I₀ has a 384×288-pixel resolution and where areas 407a and 407b are two horizontal strips of 384×100 pixels, it may be provided, at step 401, to exclude two horizontal strips of 384×75 pixels (at the scale of image I₀) from the search. An image I₁ of smaller size than image I₀ is first computed, which corresponds to a simulation of an image which could have been acquired with a sensor of lower resolution. As an example, the size of image I₁ is smaller by a factor 1.5 than the size of image I₀. At the scale of image I₁, the areas excluded from the search thus are, in this example, two horizontal strips 407a′ and 407b′ of (384/1.5)×(75/1.5)=192×50 pixels, respectively extending from the lower edge and from the upper edge of image I₁.

Image I₁, excluding areas 407a′ and 407b′, is then scanned by using the same sliding detection window r₀ as at step 400. For each shifting of window r₀, an algorithm is implemented to determine whether the searched object is or not contained within window r₀ at a size on the order of that of window r₀. Step 401 thus enables, in this example, to detect the searched object if its size in image I₁ is on the order of 24×24 pixels, that is, if its size in image I₀ is on the order of (1.5*24)×(1.5*24)=36×36 pixels.

At step 402, it is attempted to detect the possible presence of the object a relatively short distance from the camera (search scale greater than that of step 401). At such a distance, the object may be anywhere in the image taken by the camera. It is thus provided to carry on the search across the entire image, without excluding any area from the search. Step 402 is for example identical to step 102 of the method of FIG. 1.

FIG. 5 schematically illustrates steps of a variation of the multi-scale search method of FIG. 4, corresponding to the case where, between two search steps at different search scales, the search scale is modified by, instead of decreasing the size of the scanned image (as in the examples of FIGS. 1 and 4), increasing the size of the sliding detection window (as in the example of FIG. 2).

In the shown example, three steps 500, 501, and 502 of search of the object in image I₀, at three different search scales, are provided.

At step 500, it is attempted to detect the possible presence of the object a relatively large distance from the camera (small search scale). Areas excluded from the search are defined in image I₀, for example, two horizontal strips 507a and 507b of 384×100 pixels for an image I₀ of 384×288 pixels, respectively extending from the lower edge and from the upper edge of image I₀. A sliding detection window r₀, for example, a square 24×24-pixel window, is used to scan the entire image I₀, excluding strips 507a and 507b. For each shifting of window r₀, an algorithm is implemented to determine whether the searched object is or not contained within window r₀ at a size on the order of that of window r₀.

At step 501, it is attempted to detect the possible presence of the object at a distance from the camera smaller than the search distance of step 500 (greater search scale than at step 500). Smaller exclusion areas than at step 500 are defined in image I₀, for example, two horizontal strips 507a′ and 507b′ of 384×75 pixels respectively extending from the lower edge and from the upper edge of image I₀. A new sliding detection window r₁, of larger size than window r₀, is defined. As an example, the size of window r₁ is larger by a facture 1.5 than that of window r₀. The entire image I₀, excluding strips 507a′ and 507b′, is scanned by means of window r₁. For each shifting of window r₁, a detection algorithm is implemented to determine whether the searched object is or not contained in window r₁ at a size on the order of that of window r₁ ((24*1.5)×(24*1.5)=36×36 pixels in this example).

At step 502, it is attempted to detect the possible presence of the object a relatively short distance from the camera (search scale greater than that of step 501). It is provided to carry on the search across the entire image, without excluding any area from the search. Step 502 is for example identical to step 202 of the method of FIG. 2.

In many cases (see for example the illustration in FIG. 3), the areas which can be excluded from the search are delimited, in a cross-section view in a vertical or horizontal plane orthogonal to that of the sensor, by the area comprised between a straight line (respectively 309a and 309b for areas 307a and 307b of FIG. 3) and an outer edge of the field of view of the camera (respectively lower edge 311a and upper edge 311b for areas 307a and 307b of FIG. 3). In a preferred embodiment, it is provided to define, according to the configuration of the detection system, a high search scale threshold beyond which no area of the original image is excluded from the search, as well as a simple function, for example, a linear function enabling, at search scales smaller than this threshold, to automatically compute, according to the search scale, the size of the areas of image I₀ that can be excluded from the search.

As a variation, it may be provided to predefine, for each of the search scales which are planned to be used to detect an object in a given original image I₀, the size of the areas of image I₀ that can be excluded from the search.

An advantage of the provided embodiments is that they enable, as compared with multi-scale search methods of the type described in relation with FIGS. 1 and 2, to significantly decrease the number of computing operations which must be implemented in a search. It should be noted that the gain is all the greater as, in known search methods, the search steps at the smallest scales usually comprise the greater number of computing operations. Now, in the provided embodiments, the largest image portions are precisely excluded from the search in the search steps at the smallest scales.

FIG. 6 schematically illustrates an embodiment of a device 600 of multi-scale detection of an object in an image. Device 600 comprises an image sensor 601 (IMAGE SENSOR), for example, a sensor of an image acquisition device such as a camera, and a memory 602 (MEM) which stores images taken by sensor 601. Device 600 further comprises a processing and calculation unit 603 (UC), for example, a microprocessor. Processing unit 603 is configured to process images taken by sensor 601 and stored in memory 602 according to a method of the type described in relation with FIGS. 4 and 5, to search for the possible presence of one or several objects to be detected in these images. Device 600 may further comprise a display device 604 (DISP), for example, a display screen, to notify a user when one or several of the searched objects have been detected, and possibly display the images taken by sensor 601.

Specific embodiments of the present invention have been described. Various alterations, modifications, and improvements will readily occur to those skilled in the art.

In particular, the present invention is not limited to the numerical examples mentioned hereinabove as an illustration, especially as concerns the size of the images, of the detection windows, of the search exclusion areas, of the search scale multiplication factors between two successive search steps at different scales, etc.

Further, the present invention is not limited to the specific example described hereinabove where the areas excluded from the search at certain search steps are horizontal strips at the bottom and at the top of the image. According to the system configuration, and in particular according to the orientation of the camera and to the nature of the observed scene and to the objects to be detected, other shapes of exclusion areas may be provided, for example, vertical strips, a shape complementary to that of a diaphragm, etc.

Further, an embodiment of a multi-scale object detection device capable of implementing a method of the type described in relation with FIGS. 4 and 5 has been described hereabove in relation with FIG. 6. It will be within the abilities of those skilled in the art to provide other processing devices capable of implementing the desired operation.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for detecting an object in an image using an image processing device, the method comprising performing several steps of object search in the image at different search scales, wherein during at least one of the search steps, portions of the image are excluded from the search, wherein the size of the portions decreases as the search scale increases.

2. The method of claim 1, wherein, at each of the search steps, a sliding detection window is used to scan the image or a resized image representative of the image, a detection algorithm being implemented on each shifting of the window to determine whether the searched object is or not contained within the window at a size on the order of that of the window.

3. The method of claim 2, wherein, between two successive search steps at different search scales, the search scale change is performed by modifying the size of the image scanned by the window.

4. The method of claim 2, wherein, between two successive search steps at different search scales, the search scale change is performed by modifying the size of the sliding window.

5. The method of claim 1, wherein, when the search scale is greater than a threshold, no portion of the image is excluded from the search.

6. The method of claim 5, wherein, when the search scale is smaller than the threshold, the size of the portions depends on the search scale according to a linear function.

7. The method of claim 1, wherein the object to be detected is a face.

8. The method of claim 1, wherein the object to be detected is a vehicle.

9. A method for detecting an object in an image using an image processing device, the method comprising:
performing first search by sequentially searching first search portions of the image for the object, each first search portion being a first size, wherein an excluded portion of the image is not searched while performing the first object search; and
performing second search by sequentially searching second search portions of the image for the object, each second search portion being a second size that is bigger than the first size.

10. The method of claim 9, wherein performing the second search comprises searching the entire image.

11. The method of claim 9, wherein performing the second search comprises searching the image except for a second excluded portion, the second excluded portion being smaller than the excluded portion.

12. The method of claim 11, further comprising performing third search by sequentially searching third search portions of the image for the object, each third search portion being a third size that is bigger than the second size.

13. The method of claim 12, wherein performing the third search comprises searching the entire image.

14. The method of claim 9, further comprising performing third search by sequentially searching third search portions of the image for the object, each third search portion being a third size that is bigger than the second size.

15. The method of claim 14, wherein the ratio of the second size to the first size is the same as the ratio of the third size to the second size.

16. The method of claim 9, wherein the excluded portion comprises a horizontal strip.

17. The method of claim 16, wherein the excluded portion comprises a first horizontal strip located at an upper portion of the image and a second horizontal strip located at a lower portion of the image.

18. The method of claim 9, wherein performing the first search comprises using a first sliding detection window to scan the image and wherein performing the second search comprises using a second sliding detection window to scan the image.

19. The method of claim 18, wherein performing the first and second searches each further comprises determining whether the object is or not contained within the window.

20. The method of claim 19, wherein determining whether the object is or not contained within the window comprises determining whether the object is or not contained within the window at a size on the order of that of the window.

21. The method of claim 18, wherein the second sliding window is bigger than the first sliding window.

22. The method of claim 18, wherein the second sliding window is the same size as the first sliding window, the size of the image being adjusted for the second search relative to the first search.

23. The method of claim 9, wherein searching first search portions of the image comprises searching first search portions of a resized image representative of the image.

24. The method of claim 9, wherein searching second search portions of the image comprises searching second search portions of a resized image representative of the image.

25. The method of claim 9, wherein the object to be detected is a face.

26. The method of claim 9, wherein the object to be detected is a vehicle.

27. A device for detecting an object in an image, the device comprising:
a processing unit; and
a memory coupled to the processing unit and configured to store the image;
wherein the processing unit is configured to perform several steps of object search in the image at different search scales, wherein during at least one of the search steps, portions of the image are excluded from the search, wherein the size of the portions decreases as the search scale increases.

28. The device of claim 27, further comprising an image sensor coupled to the memory.

29. The device of claim 27, wherein the processing unit comprises a microprocessor.

30. A device comprising:
a processor coupled to a memory;
wherein the processor is programmed to detect an object in an image by:
performing first search by sequentially searching first search portions of the image for the object, each first search portion being a first size, wherein an excluded portion of the image is not searched while performing the first object search; and
performing second search by sequentially searching second search portions of the image for the object, each second search portion being a second size that is bigger than the first size.
